(19) United States
(12) Patent Application Publication
(10) Pub. No.: US 2024/0027226 A1
(43) Pub. Date: Jan. 25, 2024

(54) METHOD FOR DETERMINING OBJECTS IN AN ENVIRONMENT FOR SLAM

(71) Applicant: Robert Bosch GmbH, Stuttgart (DE)

(72) Inventors: Christian Juette, Redwood City, CA (US); Narunas Vaskevicius, Renningen (DE); Peter Biber, Ammerbuch (DE); Reza Sabzevari, Hildesheim (DE); Stefan Benz, Kirchentellinsfurt (DE); Timm Linder, Boeblingen (DE)

(21) Appl. No.: 18/331,351

(22) Filed: Jun. 8, 2023

(30) Foreign Application Priority Data
Jun. 15, 2022 (DE) 10 2022 206 041.5

(51) Int. Cl. G01C 21/00

(52) U.S. Cl. CPC G01C 21/3848

(57) ABSTRACT

A method for determining objects in an environment with the aid of SLAM and a mobile device in the environment, which has at least one sensor for acquiring object and/or environment information. The method includes: providing sensor data, carrying out an object detection in order to obtain first object datasets for detected objects; carrying out object tracking for a new SLAM dataset, including allocating objects detected with the aid of the object detection to real objects in order to obtain second object datasets or real objects to be considered in the SLAM graph.

### FIELD

The present invention relates to a method for determining objects in an environment with the aid of SLAM and a mobile device in the environment, and to a system for data processing, a mobile device, and a computer program for its execution.

### BACKGROUND INFORMATION

Mobile devices such as vehicles or robots moving in an at least semi-automated manner typically move in an environment, in particular an environment to be processed or a work region such as in a home, in a garden, in a factory space or on the road, in the air or in the water. One of the fundamental problems of such a mobile device or also some other mobile device is its orientation, that is, to know the layout of the environment, i.e., especially where obstacles or other objects are located, and where it is located itself (in absolute terms). To this end, for example, the mobile device is equipped with different sensors, e.g., cameras, lidar sensors or also inertial sensors, with whose aid the environment and the movement of the mobile device are acquired, e.g., in a two- or three-dimensional manner. This allows for a local movement of the mobile device, the timely detection of obstacles, and their circumvention.

If the absolute position of the mobile device is also known, for instance from additional GPS sensors, a map is able to be set up. The mobile device then measures the relative position of possible obstacles in relation to itself and can then determine based on its own position the absolute positions of the obstacles, which are subsequently entered into the map. However, this functions only if externally provided position information is available.

SLAM (“Simultaneous Localization and Mapping”) is the name of a method in robotics in which a mobile device such as a robot can or must simultaneously set up a map of its environment and estimate its own position in space within this map. It is therefore used for detecting obstacles and thus aids in an autonomous navigation.

### SUMMARY

According to the present invention, a method for determining objects in an environment and a system for data processing, a mobile device and a computer program for its execution are provided. Advantageous example embodiments of the present invention are disclosed herein.

The present invention focuses on the topic of SLAM and its application in mobile devices. Examples of such mobile devices (or also mobile work devices), for instance, are robots and/or drones and/or also vehicles that are moving in a partially or (fully) automated manner (on land, in water or in the air). For example, household robots such as vacuum and/or wiping robots, devices for cleaning floors or streets or lawnmower robots are possible, but also other so-called service robots, e.g., passenger vehicles or vehicles transporting goods (also what is known as industrial trucks such as used in warehouses), as well as aircrafts such as drones, or water vehicles may be considered vehicles that are moving in a partially automated manner.

Such a mobile device especially has a control unit and a drive unit for moving the mobile device so that the mobile device is able to be moved in the environment and along a trajectory, for example. In addition, a mobile device has one or more sensor(s) by which information relating to the environment and/or objects (in the environment, especially obstacles) and/or relating to the mobile device itself is able to be acquired. Examples of such sensors are lidar sensors or other sensors for determining distances, cameras, as well as inertial sensors. In the same way, what is known as an odometry (of the mobile device) is able to be taken into consideration.

There are different approaches in SLAM for representing maps and positions. Conventional methods for SLAM are usually based exclusively on geometrical information such as nodes and edges or areas. For example, points and lines are or include certain manifestations of features that are able to be detected in the environment. Nodes and edges, on the other hand, are or include components of the SLAM graph. The nodes and edges in the SLAM graph may have different developments; traditionally, the nodes correspond to the pose of the mobile device, for instance, or to certain environment features at certain points in time, whereas the edges represent relative measurements between the mobile device and an environment feature. In the present case, nodes and edges, for instance, may also be represented in some other way; a node, for instance, could include not only the pose of an object but also its dimensions or color, as will be described in greater detail in the further text.

Geometrical SLAM is known as such and, for instance, represented as a pose-graph optimization (pose stands for the position and orientation), in which the mobile device (or a sensor there) is tracked with the aid of a simultaneously reconstructed dense map. In this context, mention of a SLAM graph in which the existing information is included will also be made in the following text. For example, this is described in “Giorgio Grisetti et al., “A Tutorial on Graph-Based SLAM;” in: IEEE Intelligent Transportation Systems Magazine 2.4 (2010), pp. 31-43”.

In particular, given the availability of what are known as deep learning techniques, a focus in SLAM has shifted to the so-called semantic SLAM. In addition to the geometrical aspects, its aim is to profit from a semantic understanding of the scene or environment and to simultaneously provide noisy semantic information from deep neural networks with spatially-temporal consistency.

One aspect in this context is the handling of uncertainties in semantic SLAM, that is, the handling of noisy object detections and the resulting ambiguity of the data allocation. Against this background, a possibility for determining—and especially also tracking-objects in an environment with the aid of SLAM and a mobile device in the environment is provided.

According to an example embodiment of the present invention, sensor data, which include information about the environment and/or about objects in the environment and/or about the mobile device are provided for this purpose, which are acquired or were acquired with the aid of the at least one sensor of the mobile device. Thus, these are, for example, lidar data (i.e., point clouds, for instance) and/or camera data (i.e., images, also in color, for instance), and/or inertial data (e.g., accelerations). Such sensor data are typically acquired on a regular or repeated basis while the mobile device is moving in the environment, or possibly also while the mobile device is not moving but is at a standstill.

An object detection then takes place based on the sensor data in order to obtain first object datasets for detected objects; this is accomplished in particular for a recording time window in each case. A recording time window is to be understood as a time window or frame in which a sensor acquires a dataset, that is, executes a lidar scan or records an image. To begin with, the sensor data may also be synchronized and/or preprocessed before the object detection is carried out. This is useful in particular if the sensor data include information or data acquired with the aid of multiple sensors, especially different types of sensors. In this way, the different types of sensor data or information are then able to be processed simultaneously. The object detection then takes place based on the synchronized and/or preprocessed sensor data (but always still based on the sensor data itself, although indirectly).

According to an example embodiment of the present invention, in the object detection, objects are then detected in the sensor data, in particular for each recording time window. Objects in an image and/or a lidar scan (point cloud) may thus be detected, for instance. Examples of relevant detectable objects, for instance, are a plastic crate, a forklift, a mobile robot (one that differs from the mobile device itself), a chair, a table, or a line marking on the ground.

It should be mentioned at this point that here and in the following text, objects and other things are mentioned in the generic plural. It is also understood that, theoretically, only one or no object at all is present or detected. In this case, only one or no object will thus be detected in the object detection, which means that the number of detected objects will then be one or zero.

The underlying object detector (which carries out the object detection), for example, may be implemented as a deep neural network, which operates using color images, depth images/point clouds or a combination thereof such as described in Timm Linder et al.; “Accurate detection and 3D localization of humans using a novel YOLO-based RGB-D fusion approach and synthetic training data;” in: 2020 IEEE International Conference on Robotics and Automation (ICRA). 2020, pp. 1000-1006, Xingyi Zhou, Dequan Wang, and Philipp Krahenbuhl; “Objects as Points;” 2019. arXiv: 1904.07850, or Charles R. Qi et al.’ “Frustum PointNets for 3D Object Detection from RGB-D Data;” in: 2018 IEEE/CVF Conference on Computer Vision and Pattern Recognition. 2018, pp. 918-927”.

For instance, the detector is trained with the aid of supervised learning techniques on a previously marked dataset, although semi-supervised learning or self-supervised methods may also be used for the object detection. For certain objects such as objects that have a symmetrical shape, conventions with regard to their canonical alignment (e.g., where the “front side” is located) may be specified by a human annotator a priori.

According to an example embodiment of the present invention, the first object datasets relating to the detected objects (that is, a first object dataset exists for each detected object) preferably include values relating to spatial parameters in each case, the spatial parameters including a position and/or an orientation and/or a dimension, and especially also spatial uncertainties of the spatial parameters. In the same way, for example, the first object datasets relating to the detected objects may include information about a detection accuracy (or detection probability) and/or a class allocation (that is, which type of object is involved, for instance). For example, detected objects may be represented by oriented 3D bounding boxes in the sensor coordinate system (although other representations such as 3D centroids, or instance masks are also possible).

In this case, each object in the 3D space may particularly be represented by a 9D vector, which includes its position vector (x, y, z) and its orientation, e.g., in Euler angles (roll, pitch, yaw angle) which in combination are referred to as a 6D pose of the object, as well as spatial dimensions (length, width, height).

According to an example embodiment of the present invention, in the object detection, multiple objects are thus typically detected, especially also for each recording time window. The detected objects or the corresponding first object datasets may then be cached in a cache, for example. It should be mentioned that this object detection may especially be carried out for each new recording time window and the sensor data received there, so that new first object datasets are always added. Moreover, the first object datasets may include time stamps in order to allow for a later identification or allocation.

Next, an object tracking for a new SLAM dataset which is to be added to a SLAM graph is carried out. This particularly means that the SLAM graph is to be updated by new data, in the process of which objects detected especially since the last update (that is, since the last addition of a SLAM dataset) are allocated to objects already existing in the SLAM graph. This may also be referred to as tracking. If objects were detected that do not exist yet, new objects may be set up in the SLAM graph.

In this context, especially all first object datasets that have been determined or generated since the last addition of a SLAM dataset (this is also referred to as a keyframe) and are stored in the mentioned buffer memory, for example, are taken into consideration. A transformation of the first object datasets is preferably performed for this purpose at the outset. As mentioned, these first object datasets include a 6D pose of the objects, for instance, which typically applies to a sensor coordinate system (CS)_{S} at instant t. This pose is or was detected by the object detector. In addition, there is typically a so-called reference coordinate system (CS)_{R}, which describes the pose of the sensor coordinate system in the last keyframe or in the last SLAM dataset. For instance, an odometry source of the mobile device then supplies the transformation:

$${T}_{R S}^{t} = ( \begin{matrix}R o {t}_{R S}^{t} & t {r}_{R S}^{t} \\ {0}^{T} & 1\end{matrix} )$$

with rotation Rot∈ [symbol] ^{3×3} and translation tr∈ [symbol] ³ for the time step t between (CS)_{R} and (CS)_{S}. To allow for a meaningful aggregation of the detections in the subsequent step, it is therefore possible to transform the poses P_{S} of all detected objects with their respective time stamps t into the shared reference coordinate system in the following manner:

P_{R}^{t}=T_{RS}^{t}·P_{S}^{t}

According to an example embodiment of the present invention, the objects detected with the aid of the object detection since a preceding SLAM dataset are then allocated to real objects based on the first object datasets so as to obtain second object datasets for real objects to be considered in the SLAM graph. These second object datasets may then be supplied, for example. The background is that in each recording time window—and there are typically multiple recording time windows since the last SLAM dataset—individual objects are detected, which represent the same real object, however. Moreover, each of the multiple sensors may also detect objects that represent the same real object. In other words, multiple (usually different) first object datasets are associated with a real object that is ultimately to be represented by a second object dataset for the SLAM graph.

For this allocation (also referred to as clustering), a one-dimensional, monotonic (simple or strictly monotonic) distance measure, for example, may be defined between a pair of detected objects k and l. The distance measure d_{k,l} may then be specific to the object class, for instance, and be adapted in such a way that it best matches the type of objects that are to be detected.

In the simplest case, d_{k,l} could be the point-to-point distance in the metric space between the centers of the detected objects. Further object characteristics such as the extension, orientation, color, etc. are also able to be taken into account. For detections that belong to different classes, d_{k,l} may be set to a (large) constant such as to infinity.

The goal of the allocating (clustering) thus is a combination of detected objects (or object detections) since the previous keyframe or SLAM dataset, that is, from a short time window, which all correspond to the same real object. For instance, if the sensor was moved on a circular path around a chair, this chair was observed from different points of view, which leads to multiple individual object detections of the same chair, i.e., the same real object.

Carrying out the allocation in each SLAM dataset thus enables the integration of the objects into the SLAM graph, which takes place following or with each SLAM dataset. This allocation limits the computational work of the global optimization (in comparison with an optimization for each recording time window) so that the system is able to efficiently process also larger environments or scenes. In addition, it is helpful in combining extended objects (e.g., long lines or large shelves), which can only be partially monitored over time within a recording time window. Finally, the allocating or clustering is helpful in handling noisy detections in a more robust manner (that is, with missing observations or false detections).

Different algorithms may be used for the allocating or clustering. Since a SLAM dataset normally covers a relatively short time window, it is unlikely that the sensor position will change significantly between two SLAM datasets. For instance, it may also be provided that (after an adjustment of a system, for instance), a new keyframe is triggered only once a certain adjustable distance has been traveled by the mobile device. In this way, it is achieved that the sensor position does not change to any significant extent. In a static scene or environment, for instance, it may thus be assumed that the poses of the detected objects remain relatively stable so that a simple but computationally efficient strategy for linking multiple detections of the same real object may already provide good results.

One preferred algorithm (known as a so-called greedy clustering approach) includes sorting of the detected objects according to an allocation criterion, determining a distance measure between two detected objects in each case, and allocating two detected objects to the same real object for which the distance measure undershoots a predefined distance threshold value. This will be described in greater detail in the following text.

Let it be assumed that N objects were detected (detections) since the last SLAM dataset (or keyframe), which are meant to be allocated to M different real objects (M possibly being unknown a priori), and all detections are represented in a common reference coordinate system (CS)_{R}. As a first step, these detected objects may be sorted in a list L, i.e., based on a quality measure Q, such as the detection likelihood or detection accuracy of the object detector (which is based on a neural network, for example), or the length of a line detected for a line detector.

For two detected random objects i and j, the distance metrics or distance measure d_{i,j} (as described above) and quality measure Q are to satisfy the following characteristic:

d_{i,j}≥d_{j,i},if Q(i)>Q(j)

Next, the pairwise distances between all sorted detected objects in list L are precalculated using the previously defined distance measure. Distance d_{i,j} of each detected object i∈(1 . . . N) relative to all other detected objects j∈(i . . . N) is able to be calculated and stored and/or held in a distance matrix D∈ [symbol] ^{N×N}.

In addition, a distance threshold value θ in the sense of a maximum distance measure, below which two detected objects are determined as belonging to the same real object, is able to be defined. Detected objects may first be iteratively preprocessed in a row-wise manner by iterating across the rows of matrix D beginning with the detected object in the first row, that is, the object having the highest quality measure. For each row i of matrix D, all columns j having a distance d_{i,j}<θ represent an allowed allocation, so that the real object results. These allocations, for example, may be marked in a binary allocation matrix A∈{0,1}^{N×N} by setting the corresponding entry a_{i,j} to 1. Each column having at least one 1 is masked out in following iterations and is no longer taken into account for the allocation to real objects.

The result of the allocation is a set of M≤N clusters of detected objects, that is, (potential) real objects. Each line i of matrix A together with its non-zero elements and the associated detected objects j forms a detection cluster that—in the ideal case—describes a single real object.

As mentioned above, the second datasets are meant to be determined or used only for real objects to be considered in the SLAM dataset. As a matter of principle, each real object determined via the mentioned allocation using the above-described algorithm, for example, may also be taken into account.

However, it is useful to make the system or method robust with respect to false positive object detections, which occur when an object was incorrectly classified by the object detector, for instance in a single recording time window. A characteristic of false detections, for instance, is that they are not persistent within a SLAM dataset or for the time window provided for this purpose and thus have no or only a few close neighbors during the clustering step. This will be utilized by the introduction of a parameter for the minimum size of clusters. For example, the minimum size may be determined also relative to the number of frames since the last keyframe. All clusters would then have to have at least this number of individual detections, or in other words, more than this predefined number of detected objects must be allocated to a real object in order to be considered a genuine positive description of a real object and thus be taken into account. In general, however, it is also possible to use a consideration criterion other than this predetermined number for determining whether a real object (or an object initially determined as a real object) is going to be considered.

According to an example embodiment of the present invention, preferably, the second object datasets are determined for each real object to be considered based on the first object datasets of the detected objects that are allocated to this real object. The detections of the individual clusters may thus be combined to form a single description or representation of the corresponding real object. This step may also be referred to as melding or merging. In the simplest case of an object representation based on centroids, this could be the center position of all detections in the cluster, for instance. For more complex object representations, more complex methods are an option in which object characteristics such as the extension, color, orientation, etc. are taken into account. A weighting of the individual detections, e.g., according to the detection quality or confidence, is possible. In other words, average values of values of the respective first object datasets are able to be used for the second object datasets.

According to an example embodiment of the present invention, preferably, an uncertainty of values in the second object datasets is also determined, i.e., based on the first object datasets of the detected objects that are allocated to the real object relating to the respective second object dataset. Independently of the object representation, the allocation and possibly merging provides for each real object k observations O={o₁, . . . , oₖ} (the first object datasets) and a (possibly merged) real object o^{m} to be considered (the second object datasets). The objects are described by a series of parameters (for example, a 3D-oriented restriction frame may be described by nine parameters—six parameters for the pose and three parameters for the extension). The observations may be used to estimate the uncertainty in the parameters of the fused (merged) object. Different approaches for the way this can be carried out are possible, some of which will be described in the following text by way of example.

In a statistical estimator, an empirical variance estimator, for instance, may be used for each one of the np parameters to calculate an approximate uncertainty σᵢ²,i=1 . . . nₚ in each of these parameters. This will then result in the following covariance matrix Σ=Diag(σ₁², . . . , σₙ_{ₚ}²), which can be made available for the pose-graph optimization.

In a local pose graph, the clustered observations may be used within the current SLAM dataset or keyframe to form a local pose graph with similar edges as in the global pose graph. After the optimization, it is possible to ascertain the covariance matrix Σ according to the optimized parameters.

The distance measures used for the cluster formation are able to evaluate the agreement between two object observations within the scope of a distance-based evaluation. For this reason, they are able to be used for moving closer to the uncertainty inherent in the cluster. One possibility of achieving this consists of calculating the squared distances dᵢ² between the observations of and the merged object o^{m}. It is then possible to define

$${o}^{2} = \frac{1}{k} {Σ}_{i} {d}_{i}^{2}$$

and to calculate the covariance as Σ=σ²Iₙ_{ₚ}ₓₙ_{ₚ}. This offers the advantage that this calculation of the uncertainty does not depend on the object representation (e.g., whether it is a line or an oriented 3D bounding box). Although this approach provides only a rough approximation of the actually underlying uncertainty, it can be calculated efficiently and reflects the relative reliability of the merged objects across multiple keyframes. Regardless of the used method, the estimated covariance matrix may become part of the optimization of the global pose graph in order to achieve a more precise pose estimate.

According to an example embodiment of the present invention, based on the second object datasets, the real objects to be considered in the SLAM graph are then preferably also allocated to real objects already included by the SLAM graph and/or the preceding SLAM dataset, and object data for the included real objects are then updated using the second object datasets. If real objects to be considered are unable to be allocated to any real objects already included in the SLAM graph and/or the preceding SLAM dataset, new object data for real objects are set up in the new SLAM dataset. It is understood that both variants can and will occur in practice, although not always for every new SLAM dataset. The new SLAM dataset is then provided and in particular added to the SLAM graph.

This allocation or setup of objects may also be referred to as the tracking of objects. The (possibly merged) detections (second object datasets) are thus tracked across SLAM datasets or keyframes in order to obtain the unique object identity over time. This may be done online and then allows for the use of object mapping in a live SLAM system in which, for example, a robot or some other mobile device is already able to physically interact with a certain previously mapped object while the map is still being set up.

In this context, classic tracking-by-detection paradigms, for example, may be followed. The merged detections of the current keyframe are used to either update already existing objects (in the SLAM graph) or to initiate new ones. This may be accomplished by solving a data-association problem, e.g., using a variant of the so-called Hungarian algorithm, such as described, for example, in H. W. Kuhn and Bryn Yaw. “The Hungarian method for the assignment problem;” in: Naval Res. Logist. Quart (1955), pp. 83-97, or James Munkres; “Algorithms for the Assignment and Transportation Problems;” in: Journal of the Society for Industrial and Applied Mathematics 5.1 (1957), pp. 32-38, which minimizes the entire allocation costs. The costs of a possible pairing between incoming observations and existing objects (tracks) are derived from a distance measure, for example, which is able to consider, for instance, the relative error in position, orientation, size, predicted class denotation or other properties that are part of the object representation. The initiation of an object, for example, is controlled by a threshold value which indicates the maximally permitted allocation costs. A detection begins a new object (track) if it is unable to be allocated to any of the existing tracks at lower costs than the predefined threshold value. For example, no special step for a state prediction is required for the imaging of static objects; as an alternative, a movement model with a zero velocity, for instance, may be assumed. Other movement models and prediction approaches such as based on Kalman/particle filters may be considered at this point. This works in particular when the keyframes are short enough (in terms of time) that the objects do not change their positions within a keyframe to any significant extent so that the cluster formation may still be successful. The result of this tracking in particular is a series of tracked objects together with their unique identities and associated characteristics (class, color, extension, . . . ) across the entire data sequence that was input into the SLAM system.

As mentioned above, the new SLAM dataset can be added to the SLAM graph. An integration of tracked objects is able to be implemented in or via the pose-graph optimization. As stated, the optimization of the pose graph (or SLAM graph) is carried out for or with each SLAM dataset (keyframe) and includes the addition of a new keyframe node to the pose graph. The keyframe node represents the relative position of the sensor in relation to the position of the previous keyframe. This procedure takes place after the above-described tracking phase.

According to an example embodiment of the present invention, in a semantically expanded SLAM system, it is now possible to add a corresponding landmark or description (“landmark”) to the pose graph, in particular for every new tracked object that is initiated by the object tracking algorithm. This landmark represents the corresponding unique object in the real world. Both for existing and for new objects or tracks, a new edge is thus added to the pose graph in each keyframe, which connects the corresponding landmark node to the current keyframe node. The edge represents the relative offset between the object pose and the respective sensor pose relative to the current keyframe. In particular, the edge includes all information about the (combined) object detected in the keyframe, that is, possibly also the detected dimensions or the detected color in addition to the relative pose.

If the SLAM graph as such, for example, is based on only 2D or only 2D poses (the third direction may be determined separately, for instance), then there are different ways of determining such new edges for the pose graph.

One type is 2D-3D pose edges. Such an edge connects a 2D pose node to a 3D pose node. Another type is 2D-3D line edges. To optimize line segments in 3D, infinite 3D lines are able to be optimized, and the length of the line segments can be reestablished again in a separate step. A map, which connects a 2D pose node to a 3D line node, may be generated for the optimization of infinite 3D lines. Its measure is likewise a 3D line in the frame of the first node.

In addition, after the processing of each keyframe or at the end of the SLAM run (in an offline operation), the mapped objects and their optimized poses are able to be called up via the landmarks of the pose graph. Through an ID-based matching, additional characteristics such as the color, etc. are able to be called up from the tracking phase and linked with each landmark. Together with the geometrical map, this then represents the final output of the semantic SLAM system, for instance.

Based on the SLAM graph, in particular also navigation information for the mobile device is provided, i.e., including object data regarding real objects in the environment, in particular also a geometrical map of the environment and/or a trajectory of the mobile device in the environment. This then enables the mobile device to navigate or ambulate in the environment.

Different advantages may be realized with the aid of the disclosed procedure according to the present invention. For example, uncertainties are better able to be managed. The robustness in the object allocation is improved. The suggested procedure allows for the consideration of noisy object detections (in the first object datasets) that often occur in practice, insofar as the determination of the second object datasets is based on multiple respective first object datasets. The provided approach is less complex and easy to implement.

The proposed procedure according to the present invention is also not connected to a specific detector, specific object types or object representations. Moreover, it is possible to process not only 3D objects (such as furniture) but 2D objects in the real world (such as line markings on the ground). An optimized 9D object representation is possible in addition, that is, a robust estimation not only of the 3D position but also the 3D extension of objects of variable sizes, e.g., desks, with the simultaneous ability of a precise estimation of 3D orientations (such as distinguishing the front or back of a chair).

The proposed procedure according to the present invention may allow for a coherent semantic and geometrical representation of a static environment, i.e., with the aid of a mobile device or information acquired by its sensor(s). This then allows for further subsequent tasks.

For example, a simpler interaction between a person and a mobile device, in particular a robot, is possible (such as a teach-in, setting a task). The comprehensibility, interpretability and transparency of the recorded environment map are able to be improved. Semantically valid decision finding and planning in mobile devices can be achieved. In addition, inputs from multiple different noisy or imperfect object detectors and/or generic semantic detection modules are able to be processed.

A system according to the present invention for data processing such as a control unit of a robot, a drone, a vehicle, etc. is developed, especially in terms of the programming technology, to carry out a method according to the present invention.

Although it is especially advantageous to carry out the mentioned method steps on the processing unit in the mobile device, some or all method steps are able to be carried out on some other processing unit or processor such as a server (cloud); for this purpose, a preferably wireless data or communication link is required between the processing units. As a result, a processing system is available for carrying out the method steps.

The present invention also relates to a mobile device to obtain navigation information as mentioned above and to navigate based on navigation information. This may be, for instance, a passenger vehicle or an industrial goods truck, a robot, in particular a household robot such as a vacuum and/or wiping robot, a floor or street cleaning device or lawnmower robot, a drone or also combinations thereof. In addition, the mobile device may include one or more sensor(s) for the acquisition of object and/or environment information. The mobile device may furthermore especially be equipped with a control unit and a drive unit for moving the mobile device.

The implementation of a method according to the present invention in the form of a computer program or computer program product having program code for carrying out all method steps is also advantageous because it involves an especially low expense, in particular when an executing control unit is also used for further tasks and thus is provided anyway. Finally, a machine-readable memory medium is provided with a computer program stored thereon, as described above. Suitable memory media or data carriers for providing the computer program in particular are magnetic, optical and electric memories such as hard disks, flash memories, EEPROMs, DVDs and others. A download of a program via computer networks (internet, intranet, etc.) is also possible. Such a download may take place in a wire-conducted or cable-bound or in a wireless manner (e.g., via a WLAN network, a 3G-, 4G-, 5G- or 6G-connection, etc.).

Additional advantages and embodiments of the present invention result from the description and the figures.

The present invention is schematically illustrated in the figures based on an exemplary embodiment and is described in the following text with reference to the figures.

### BRIEF DESCRIPTION OF THE DRAWINGS

FIG. 1 schematically shows in a preferred embodiment a mobile device in an environment to describe the present invention.

FIG. 2 schematically shows in a preferred embodiment a flow diagram to describe the present invention.

### DETAILED DESCRIPTION OF EXAMPLE EMBODIMENTS

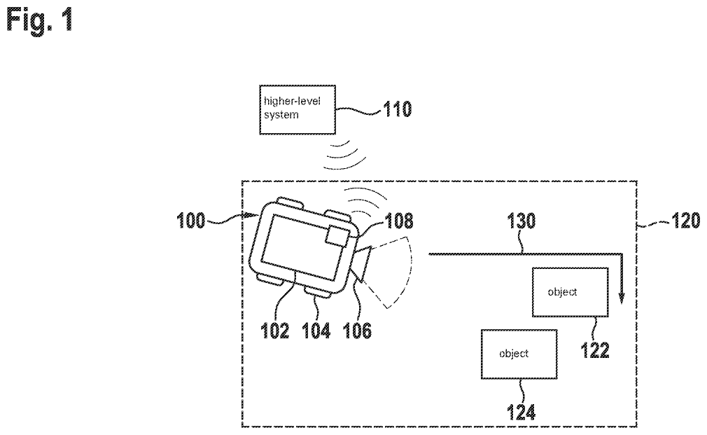

FIG. 1 schematically and simply by way of example shows a mobile device 100 in an environment 120 to describe the present invention. Mobile device 100, for example, may be a robot such as a vacuum or lawnmower robot, which includes a control unit 102 and a drive unit 104 (with wheels) for moving robot 100, e.g., along a trajectory 130. As mentioned, however, it may also be some other type of mobile device, such as a vehicle transporting goods.

In addition, robot 100 exemplarily has a sensor 106, which is developed as a lidar sensor and has an acquisition field (sketched by dashed lines). For a better understanding, the acquisition field has been selected to be relatively small; in practice, however, the acquisition field may also amount to up to 360° (but at least 180° or at least 270°). With the aid of lidar sensor 106, object and environment information such as the distances of objects is able to be acquired. Two objects 122 and 124 are shown by way of example. Apart from or instead of the lidar sensor, the robot may also have a camera, for instance.

Robot 100 furthermore has a system 108 for data processing such as a control unit with the aid of which data are able to be exchanged, e.g., via a sketched radio link, with a higher-level system 110 for data processing purposes. In system 110 (such as a server but it may also be a so-called cloud), it is possible to determine from a SLAM graph navigation information including trajectory 130, which is then conveyed to system 108 in lawnmower robot 100, on the basis of which this device is then meant to navigate. However, it may also be provided that navigation information be determined in system 108 itself or obtained there from some other source. Instead of navigation information, however, system 108 may also receive control information that has been determined with the aid of the navigation information and according to which control unit 102 can move robot 100 via drive unit 104, for instance in order to follow trajectory 130.

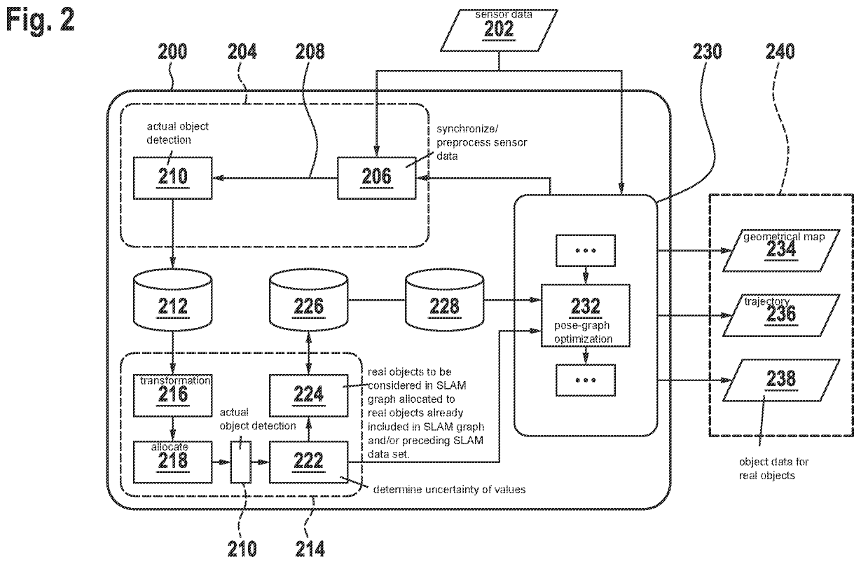

FIG. 2 schematically shows a flow diagram to describe the present invention in a preferred embodiment. Here, 200 generally denotes a SLAM system or a SLAM architecture which represents a method according to the present invention in a preferred embodiment.

To this end, sensor data 202 are supplied, which include information about the environment and/or objects in the environment and/or the mobile device. These sensor data 202 are acquired with the aid of the lidar sensor of the mobile device or additional sensors, for instance. Such sensor data are typically acquired on a regular or repeated basis while the mobile device is moving in the environment.

Based on sensor data 202, an object detection is then to be performed; this is implemented for a recording time window or frame 204 in each case. In this case, a recording time window, for instance, is a time window in which a lidar scan is performed with the aid of the lidar sensor. Sensor data 202 may first be synchronized and/or preprocessed in block 206. This is useful especially when the sensor data include information or data acquired with the aid of multiple sensors, in particular different types of sensors.

The synchronized and/or preprocessed sensor data 208 are then transmitted to the actual object detection 210 (this may also be called an object detector). First object datasets 212 in connection with detected objects are obtained by the object detection. Objects for each recording time window are detected in the sensor data in the object detection. For instance, objects may thus be detected in a lidar scan (point cloud). Examples of relevant detectable objects are a plastic crate, a forklift, a mobile robot (other than the mobile device itself), a chair, a table, or a line marking on the ground.

Multiple objects are typically detected in object detection 210, i.e., especially also in each recording time window. The detected objects or the corresponding first object datasets 212 may then be cached in a cache, for instance. It should be mentioned that this object detection may be carried out for every new recording time window or for the sensor data received there, so that new first object datasets 212 are always added. In addition, first object datasets 212 may include time stamps to allow for a later identification or allocation.

This is followed by an object tracking for a new SLAM dataset 214 which is to be added to a SLAM graph 230. This particularly means that SLAM graph 230 is to be updated by new data, in the process of which objects detected since the last update (that is, since the last addition of a SLAM dataset) are allocated to objects already existing in the SLAM graph. This is also referred to as tracking. If objects that are not yet included are detected, new objects can be set up in the SLAM graph.

All first object datasets 212 that were determined or generated since the last addition of a SLAM dataset and, for example, are stored in the mentioned cache are taken into account in this context.

For this purpose, for instance, a transformation 216 of first object datasets 212 into a so-called reference coordinate system, which describes the pose of the sensor coordinate system in the last keyframe or in the last SLAM dataset, first takes place.

The objects detected with the aid of the object detection since a preceding SLAM dataset are then allocated 218 to real objects based on first object datasets 212 in order to obtain second object datasets 220 for real objects to be considered in the SLAM graph. The background is that objects are detected in each recording time window—and there are typically multiple ones since the last SLAM dataset—which represent the same object, however. Furthermore, each of the multiple sensors may also detect objects that represent the same real object. In other words, multiple (usually different) first object datasets 212 belong to a real object that is ultimately to be represented by a second object dataset 220 for the SLAM graph.

The aim of the allocation (clustering) is a combination of detected objects (or object detections) since the previous keyframe or SLAM dataset, that is, from a short time window, which all correspond to the same real object. As mentioned above and described in greater detail based on an example, different algorithms may be used for the allocating or clustering.

As already mentioned, the second datasets are to be determined or used only for real objects to be taken into account in the SLAM dataset. For example, it is therefore possible to disregard false positive object detections, which occur when an object is incorrectly classified by the object detector, e.g., in a single recording time window.

The detections of the individual clusters are able to be combined to form a single description or representation of the corresponding real object. This step may also be referred to as melding or merging.

It is also possible to determine an uncertainty of values in the second object datasets, block 222, i.e., based on the first object datasets 212 of the detected objects that are allocated to the real object pertaining to the respective second object dataset 220, as described above in detail.

In addition, based on second object datasets 220, the real objects to be considered in SLAM graph 230 are allocated to real objects already included in the SLAM graph and/or the preceding SLAM dataset, block 224; for instance, this involves what is known as tracking. Object data 226 pertaining to these real objects that are already available may be accessed for this purpose.

These object data 226 associated with the included real objects are then updated by second object datasets 220. If real objects to be considered are unable to be allocated to any real objects already included in the SLAM graph and/or the preceding SLAM dataset, new object data for real objects are set up in the new SLAM dataset.

This new SLAM dataset 214 is then added to SLAM graph 230. An integration of tracked objects takes place via pose-graph optimization 232. The uncertainty from block 222 may also be utilized for this purpose.

In a semantically expanded SLAM system, a corresponding landmark or description 228 (‘landmark’) may be added to SLAM graph 230, in particular for each new tracked object that is initiated by the object tracking algorithm. This landmark represents the corresponding unique object in the real world.

In addition, after each keyframe is processed or at the end of the SLAM run (in an offline operation), the mapped or detected objects or their optimized poses are called up via the landmarks of the pose graph. Through an ID-based matching, additional characteristics such as the color, etc. from the tracking phase are able to be called up and linked with each landmark. The landmarks themselves also may already have additional characteristics such as color and dimensions. These characteristics may also be optimized in the graph optimization. Together with a geometrical map of the mobile device, this then constitutes the final output of the semantic SLAM system, for instance.

Based on SLAM graph 230, navigation information 240 for the mobile device is then also provided, i.e., including object data 238 for real objects in the environment, in particular also a geometrical map 234 of the environment and/or a trajectory 236 of the mobile device in the environment. This then enables the mobile device to navigate or move in the environment.

1-15. (canceled)

16. A method for allocating objects in an environment using SLAM and a mobile device in the environment, which has at least one sensor for acquiring information about the environment and/or about objects in the environment and/or about the mobile device, the method comprising the following steps:
providing sensor data, which include information about the environment and/or about objects in the environment and/or the mobile device, which are acquired or were acquired using the at least one sensor;
performing an object detection based on the sensor data for a recording time window in each case, to obtain first object datasets for detected objects; and
performing object tracking for a new SLAM dataset, which is to be added to a SLAM graph, including:
allocating objects detected since a preceding SLAM dataset using the object detection, to real objects based on the first object datasets to obtain second object datasets for real objects to be considered in the SLAM graph.

17. The method as recited in claim 16, wherein the performing of the object tracking furthermore includes:
(i) allocating the real objects to be considered in the SLAM graph based on the second object datasets to real objects already included in the SLAM graph and/or the preceding SLAM dataset, and updating object data for the included real objects with the second object datasets, and/or (ii) setting up new object data for real objects in the new SLAM dataset when real objects to be considered are unable to be allocated to any of the real objects already included in the SLAM graph and/or the preceding SLAM dataset;
wherein the new SLAM dataset is provided and added to the SLAM graph, and based on the SLAM graph, navigation information being also provided for the mobile device, which includes object data for real objects in the environment, and a geometrical map of the environment and/or a trajectory of the mobile device in the environment.

18. The method as recited in claim 16, further comprising:
determining the second object datasets for each real object to be considered based on the first object datasets of the detected objects that are allocated to the real object, using average values of values of the first object datasets of the detected objects that are allocated to the real object.

19. The method as recited in claim 16, further comprising:
determining an uncertainty of values in the second object datasets, each based on the first object datasets of the detected objects which are allocated to the real object pertaining to the respective second object dataset.

20. The method as recited in claim 16, further comprising:
determining, according to a consideration criterion, the real objects to be taken into consideration in the SLAM graph from the real objects, the consideration criterion including that more than a predefined number of detected objects is allocated to a real object.

21. The method as recited in claim 16, wherein the allocation of the objects detected since the preceding SLAM dataset using the object detection to real objects is carried out using an algorithm in which the detected objects are sorted according to an allocation criterion, in which a distance measure is determined between two detected objects in each case, and in which two detected objects are allocated to the same real object for which the distance measure undershoots a predefined distance threshold value.

22. The method as recited in claim 16, further comprising:
synchronizing and/or preprocessing the object and/or environment information, the sensor data including information acquired using different types of sensors, and execution of the object detection taking place based on the synchronized and/or preprocessed sensor data for the recording time window in each case.

23. The method as recited in claim 16, wherein the first object datasets for the detected objects include values for spatial parameters, the spatial parameters including a position and/or an orientation and/or a dimension, and spatial uncertainties of the spatial parameters.

24. The method as recited in claim 16, wherein the first object datasets for the detected objects include information about a detection accuracy and/or a class allocation.

25. The method as recited in claim 16, wherein the at least one sensor includes one or more of the following: a lidar sensor, a camera, an inertial sensor.

26. A system for data processing, the system configured to allocate objects in an environment using SLAM and a mobile device in the environment, which has at least one sensor for acquiring information about the environment and/or about objects in the environment and/or about the mobile device, the system configured to:
provide sensor data, which include information about the environment and/or about objects in the environment and/or the mobile device, which are acquired or were acquired using the at least one sensor;
perform an object detection based on the sensor data for a recording time window in each case, to obtain first object datasets for detected objects; and
perform object tracking for a new SLAM dataset, which is to be added to a SLAM graph, including:
allocate objects detected since a preceding SLAM dataset using the object detection, to real objects based on the first object datasets to obtain second object datasets for real objects to be considered in the SLAM graph.

27. A mobile device, comprising:
at least one sensor for acquiring object and/or environment information;
a system for data processing, the system configured to allocate objects in an environment using SLAM and the mobile device in the environment, the system configured to:
provide sensor data, which include information about the environment and/or about objects in the environment and/or the mobile device, which are acquired or were acquired using the at least one sensor;
perform an object detection based on the sensor data for a recording time window in each case, to obtain first object datasets for detected objects; and
perform object tracking for a new SLAM dataset, which is to be added to a SLAM graph, including:
allocate objects detected since a preceding SLAM dataset using the object detection, to real objects based on the first object datasets to obtain second object datasets for real objects to be considered in the SLAM graph;
wherein the new SLAM dataset is provided and added to the SLAM graph, and based on the SLAM graph, navigation information being also provided for the mobile device, which includes object data for real objects in the environment, and a geometrical map of the environment and/or a trajectory of the mobile device in the environment; and
a control unit and a drive unit for moving the mobile device according to the navigation information.

28. The mobile device as recited in claim 27, wherein the mobile device is a vehicle moving in an at least semiautomated manner, the mobile device being a passenger vehicle or a vehicle transporting goods or a household robot or a lawnmower robot or a drone.

29. A non-transitory computer-readable memory medium on which is stored a computer program method for allocating objects in an environment using SLAM and a mobile device in the environment, which has at least one sensor for acquiring information about the environment and/or about objects in the environment and/or about the mobile device, the computer program, when executed by a computer, causing the computer to perform the following steps:
providing sensor data, which include information about the environment and/or about objects in the environment and/or the mobile device, which are acquired or were acquired using the at least one sensor;
performing an object detection based on the sensor data for a recording time window in each case, to obtain first object datasets for detected objects; and
performing object tracking for a new SLAM dataset, which is to be added to a SLAM graph, including:
allocating objects detected since a preceding SLAM dataset using the object detection, to real objects based on the first object datasets to obtain second object datasets for real objects to be considered in the SLAM graph.
